(19) United States
(12) Patent Application Publication
(10) Pub. No.: US 2007/0203224 A1
(43) Pub. Date: Aug. 30, 2007

(54) SMALL-MOLECULES FOR TREATING CANCER AND ABNORMAL CELL PROLIFERATION DISORDERS

(75) Inventors: Nouri Neamati, Fullerton, CA (US); George W. Kabalka, Knoxville, TN (US); Bollu Venkataiah, San Diego, CA (US); Raveendra Dayam, Los Angeles, CA (US)

Correspondence Address: HOGAN & HARTSON L.L.P., 1999 AVENUE OF THE STARS, SUITE 1400, LOS ANGELES, CA, 90067, US

(73) Assignee: University of Southern California

(21) Appl. No.: 11/621,538

(22) Filed: Jan. 9, 2007

Related U.S. Application Data
(60) Provisional application No. 60/757,334, filed on Jan. 9, 2006.

(51) Int. Cl. G06F 19/00; G06G 7/48

(52) U.S. Cl. 514/424; 702/19; 703/11; 514/471; 514/445

(57) ABSTRACT

Novel compounds and compositions that can be used to bind tubulin, prevent tubulin polymerization, inhibit cell growth, arrest cell cycle, cause cell death, or treat cancer or abnormal cell proliferation disorders. Also disclosed are methods for identifying, synthesizing, and using such compounds.

### RELATED APPLICATION

This application claims priority to U.S. Provisional Application Ser. No. 60/757,334, filed on Jan. 9, 2006, the content of which is incorporated herein by reference in its entirety.

### FIELD OF THE INVENTION

The present invention relates in general to small molecules. More specifically, the invention provides novel small molecules, compositions comprising the small molecules, methods of making the small molecules, and methods of using the compounds and compositions for treating cancer and abnormal cell proliferation disorders.

### BACKGROUND OF THE INVENTION

Cancer is one of the leading causes of death worldwide. Chemotherapeutic agents are used for the treatment of cancer and abnormal cell proliferation disorders. Chemotherapy is one of the primary methods of cancer treatment, used to stop abnormal cell growth and replication. Often, chemotherapeutic agents show adverse side effects due to lack of selectivity. There is an urgent need for development of orally bioavailable, highly selective chemotherapeutic agents with less or no side effects.

### SUMMARY OF THE INVENTION

This invention is based, at least in part, on the unexpected discovery that the small molecule compounds described below inhibit the growth of cancer cells.

Accordingly, in one aspect, the invention features a compound, or a pharmaceutically acceptable salt, solvate, or hydrate thereof, wherein the compound comprises a first hydrophobic aromatic group (HYR1), a second hydrophobic aromatic group (HYR2), a hydrophobic group (HYA), and an H-bond acceptor (HBA). HYR1, HYR2, HYA, and HBA are configured according to FIG. 1(a). The distance between HYR1 and HYR2 is 4.37±1 Å, the distance between HYR1 and HYA is 6.29±1 Å, the distance between HYR1 and HBA is 3.72±1 Å, the distance between HYR2 and HYA is 4.36±1 Å, the distance between HYR2 and HBA is 4.51±1 Å, and the distance between HYA and HBA is 3.57±1 Å.

In some embodiments, the compound is not any of PH1-37 or tubulin polymerization inhibitors 1-7 (TPI1-7), and the compound is not of Formula V.

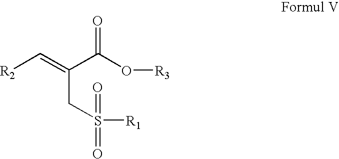

In other embodiments, the compound is not any of PH1-37 or tubulin polymerization inhibitors 1-7 (TPI1-7), and the compound is not of Formula I or V.

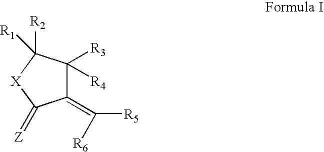

In some embodiments, the compound is of a formula selected from the group consisting of Formulas I, Ia-c, II, IIa-c, III, IIIa-c, IV, and IVa-c.

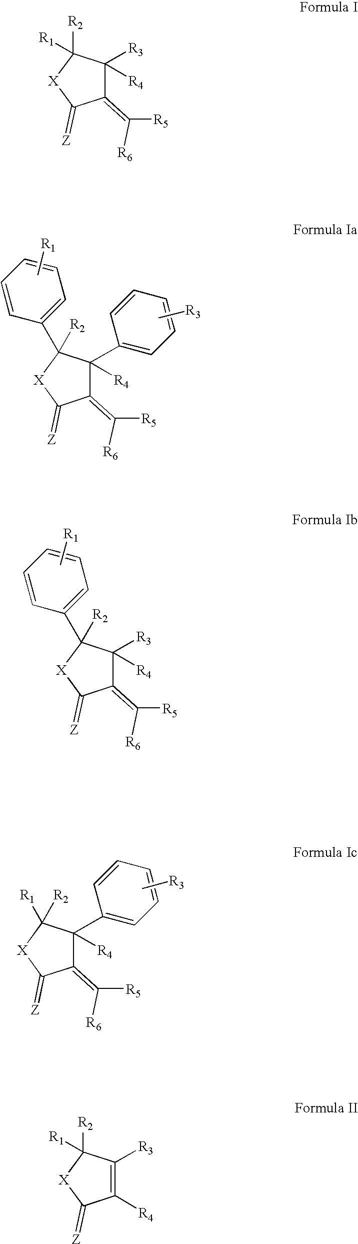

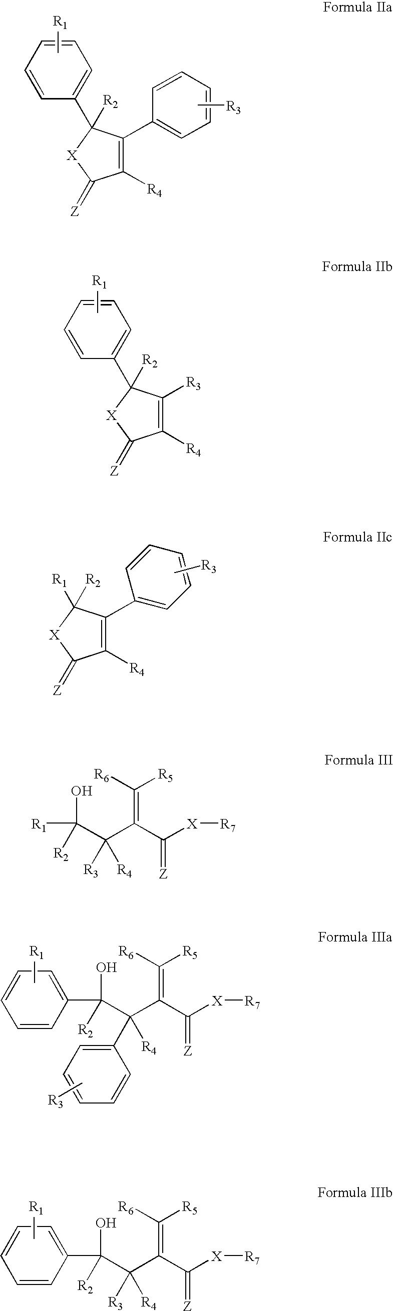

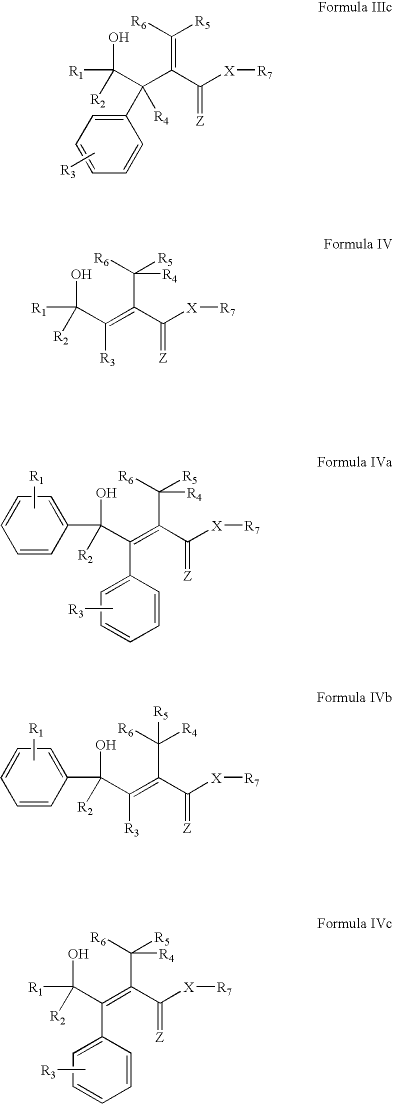

In other embodiments, the compound is of a formula selected from the group consisting of Formulas II, IIa-c, III, IIIa-c, IV, and IVa-c.

Each of R₁-R₇ is selected from the group consisting of a hydrogen atom, a halogen atom, a hydroxyl group, and any other organic group containing any number of carbon atoms in a linear, branched, or cyclic structural format. The other organic group preferably contains 1-20 carbon atoms and optionally includes a heteroatom such as oxygen, sulfur, or nitrogen. Each of X and Z is a heteroatom such as oxygen, sulfur, or nitrogen.

Representative R₁-R₇ groups include but are not limited to alkyl, substituted alkyl, alkenyl, substituted alkenyl, alkynyl, substituted alkynyl, phenyl, substituted phenyl, aryl, substituted aryl, heteroaryl, and substituted heteroaryl. Representative substitutions include but are not limited to halo, hydroxyl, alkoxy, alkylthio, phenoxy, aryoxy, cyano, isocyano, carbonyl, carboxyl, amino, amido, sulfonyl, and substituted heterocyclic.

CT10-16 and 19 are exemplary compounds of Formula I, CT20 is an exemplary compound of Formula II, CT21-22 are exemplary compounds of Formula III, and CT23 is an exemplary compound of Formula V.

A compound of Formula I or II may be synthesized according to Scheme 1.

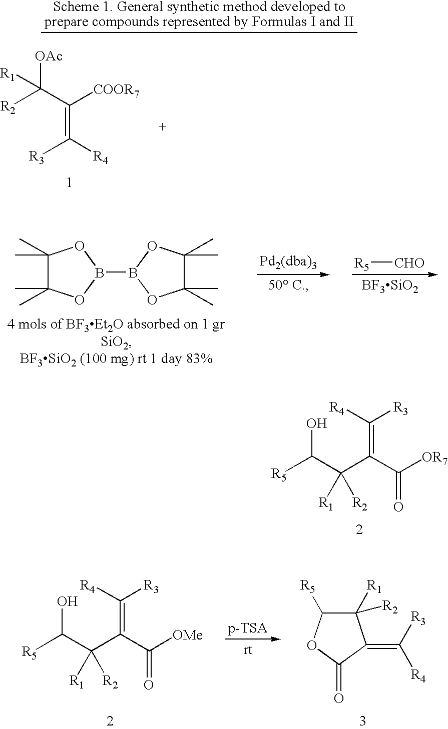

Homoallylic alcohol 2 is synthesized by a reaction of Baylis-Hillman acetate adduct 1 with bis(pinacolato)diboron, and then treated with CBr₄ and PPh₃. Homoallylic alcohol 2 reacts with carbon tetrabromide and triphenylphosphene under a nitrogen atmosphere to yield trans-α-methylenelactone 3. cis-α-methylene-lactone 3 is obtained by reacting homoallylic alcohol 2 with p-toluenesulfonic acid under a nitrogen atmosphere.

A compound of Formula III or IV may be synthesized according to Scheme 2.

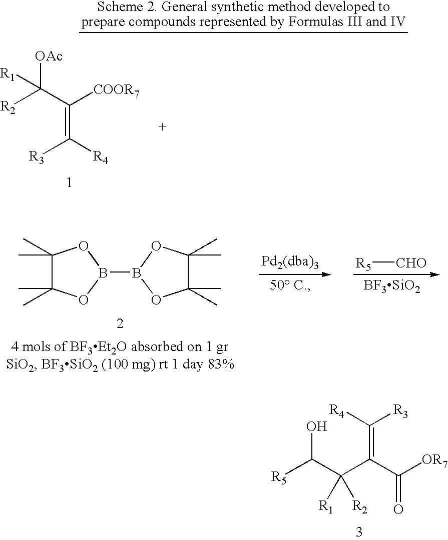

The reaction between Baylis-Hillman acetate adduct 1 and bis(pinacolato)diboron 2 is catalyzed by a palladium catalyst under a nitrogen atmosphere, followed by BF₃ in the presence of an aldehyde to form homoallylic alcohol 3.

In another aspect, the invention features a composition comprising a compound described above and a pharmaceutically acceptable carrier. In particular, the composition may contain a pharmaceutically acceptable carrier and a compound selected from the group consisting of PH1-37 and compounds of Formula V.

The invention further provides a method of binding tubulin to a compound of the invention by contacting tubulin with the compound, or a pharmaceutically acceptable salt, solvate, or hydrate thereof.

The invention also provides a method for modulating cell growth, cell cycle, or cell death. The invention involves contacting a cell with a compound of the invention, or a pharmaceutically acceptable salt, solvate, or hydrate thereof. The cell may be a cancer cell or a cell associated with an abnormal cell proliferation disorder. In some embodiments, the cell is in a subject suffering from a cancer or an abnormal cell proliferation disorder. Examples of cancer include colon cancer, breast cancer, lung cancer, ovarian cancer, brain cancer, prostate cancer, leukemia, and lymphoma; examples of abnormal cell proliferation disorders include angiogenesis disorders, immune mediated and non-immune mediated inflammatory diseases, arthritis, age-related macular degeneration, and diabetes.

In some embodiments of these methods, the compound is not any of TPI1-7. The compound may be selected from the group consisting of PH1-37 and compounds of Formula V. In some embodiments, the compound is selected from the group consisting of CT10-16 and 19-23.

In addition, the invention provides a computer-readable medium containing a representation of a pharmacophore. The pharmacophore includes features of a first hydrophobic aromatic group (HYR1), a second hydrophobic aromatic group (HYR2), a hydrophobic group (HYA), and an H-bond acceptor (HBA). HYR1, HYR2, HYA, and HBA are configured according to FIG. 1(a). The distance between HYR1 and HYR2 is 4.37±1 Å, the distance between HYR1 and HYA is 6.29±1 Å, the distance between HYR1 and HBA is 3.72±1 Å, the distance between HYR2 and HYA is 4.36±1 Å, the distance between HYR2 and HBA is 4.51±1 Å, and the distance between HYA and HBA is 3.57±1 Å.

A method for identifying a small molecule compound is also within the invention. The method involves comparing the three-dimensional structure of a test compound with the three-dimensional structure of a pharmacophore described above and selecting the test compound if the test compound conforms to the features of the pharmacophore.

The above-mentioned and other features of this invention and the manner of obtaining and using them will become more apparent, and will be best understood, by reference to the following description, taken in conjunction with the accompanying drawings. The drawings depict only typical embodiments of the invention and do not therefore limit its scope.

### BRIEF DESCRIPTION OF THE FIGURES

FIG. 1 represents common feature pharmacophore models. (a) The four-feature pharmacophore model (Hypo1) was generated on the basis of the chemical features of a set of compounds exemplified by Formulas I and II. (b) CT14 is mapped onto Hypo1. (c) A known tubulin polymerization inhibitor is reasonably mapped onto Hypo1. (d) Distances between pharmacophoric features in Å. The pharmacophore features are shown as hydrophobic aromatic (HYR1-2) in brown, hydrophobic (HYA) in blue, and H-bond acceptor (HBA) in green.

FIG. 2 illustrates DAMA-colchicine (molecule in green) bound to colchicine-binding site on the heterodimeric interface of tubulin (PDB1SA0). The representative compound, CT14, is docked onto the colchicine-binding site on tubulin. CT14 (molecule in yellow) occupies colchicine-binding site on tubulin. The α-(magenta) and β-tubulins (grey) are shown as ribbon models.

FIG. 3 depicts the predicted bound conformation of CT14 superimposed onto the bound conformation of DAMA-colchicine in the crystal structure of tubulin-DAMA-colchicine complex (PDB1SA0). CT14 adoptes a similar orientation as DAMA-colchicine. One of the two aryl rings of CT14 occupies a cavity close to Cys241 which is occupied by the colchicinoid ring in the crystal structure of tubulin-DAMA-colchicine complex. CT14 is shown as a ball and stick model (yellow) and DAMA-colchicine is shown as a stick model (green).

FIG. 4. Athymic nude mice implanted with MDA-MB-435 cells were treated with the indicated concentration of CT19 through daily i.p. administration for five days. Tumor growth was monitored for five weeks. Values represent the tumor weight (mean±SD) for each group. Treatment with CT19 significantly reduced tumor growth at 20 mg/kg p<0.05).

### DETAILED DESCRIPTION OF THE INVENTION

The object of the present invention is to provide potent chemotherapeutic agents with limited or no side effects. Synthetic methods and anticancer activities of a series of small-molecule compounds of Formulas I-V are disclosed. These compounds were synthesized using novel synthetic methodologies. Their anticancer properties were demonstrated in a panel of cancer cell lines.

A mechanism of action is provided without any intention to be bound by the theory. Based on the experimental studies, pharmacophore analysis, and docking studies, the compounds of the invention inhibit tubulin polymerization through selectively binding to tubulin at the colchicine-binding site.

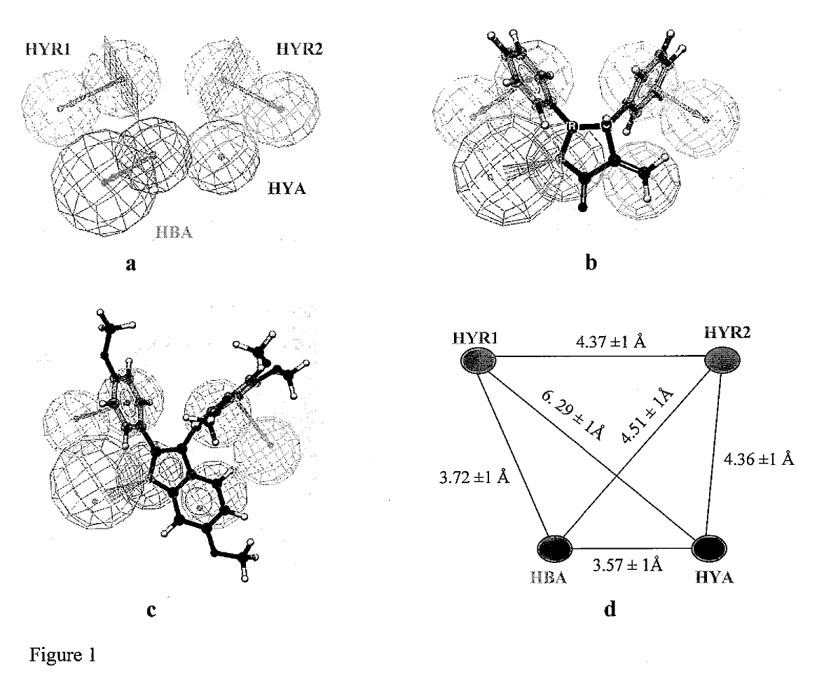

Several common feature pharmacophore models were generated according to the chemical and structural features of a set of representative compounds of Formulas I and II. These pharmacophore models were validated using a small database of reported tubulin polymerization inhibitors. The 4-feature pharmacophore model (Hypo1), shown in FIG. 1, successfully retrieved a number of previously reported tubulin polymerization inhibitors. The mapping of Hypo1 onto one of the previously reported tubulin polymerization inhibitors shows a reasonable agreement between the pharmacophoric features and the chemical features of the inhibitor (FIG. 1c).

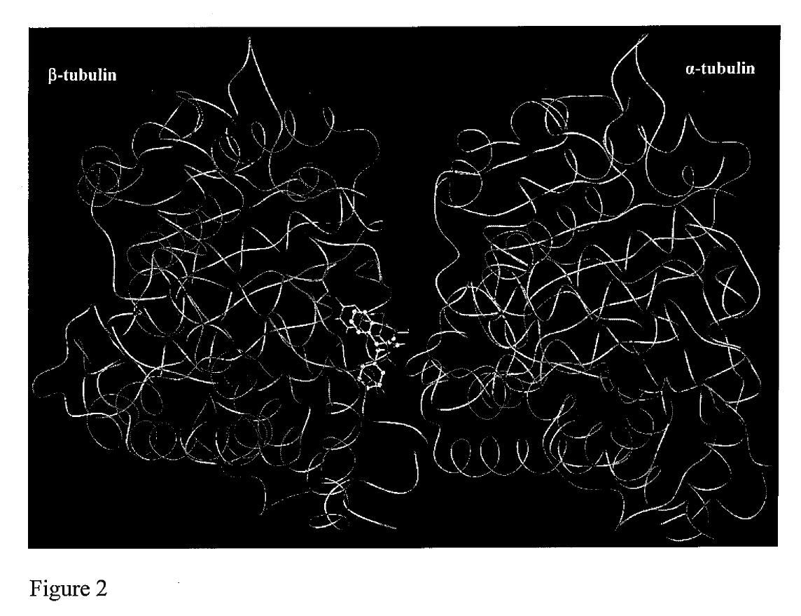

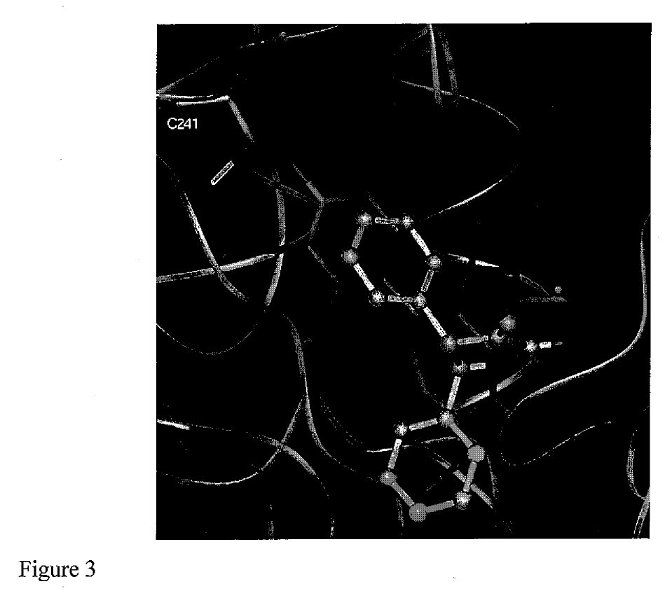

Docking studies were performed to predict bound conformation of some of the compounds of the invention inside the colchicine-binding site on tubulin. The predicted bound conformation of CT14 inside the colchicine-binding site on tubulin supports the proposed mechanism of action of these compounds. The bound conformation of CT14 is shown in FIGS. 2 and 3 along with the bound orientation of DAMA-colchicine in the crystal structure of the tubulin-DAMA-colchicine complex (PDB1SA0). CT14 occupies a cavity in the tubulin β-chain surrounded by amino acid resides T240, C241, L248, A250, K254, L255, N258, M259, T314, A316, V318, K352, and A354. Amino acid residues S178, T179, A180, and V181 from the α-chain of tubulin are located in close proximity to the CT14 binding site.

Compounds

A compound of the invention has a three-dimensional structure mapped onto Hypo1 (FIG. 1). The compound has a first hydrophobic aromatic group (HYR1), a second hydrophobic aromatic group (HYR2), a hydrophobic group (HYA), and an H-bond acceptor (HBA). HYR1, HYR2, HYA, and HBA are configured according to FIG. 1(a). The distance between HYR1 and HYR2 is 4.37±1 Å, the distance between HYR1 and HYA is 6.29±1 Å, the distance between HYR1 and HBA is 3.72±1 Å, the distance between HYR2 and HYA is 4.36±1 Å, the distance between HYR2 and HBA is 4.51±1 Å, and the distance between HYA and HBA is 3.57±1 Å.

In some embodiments of the invention, the distance between HYR1 and HYR2 may be 4.37 Å, the distance between HYR1 and HYA may be 6.29 Å, the distance between HYR1 and HBA may be 3.72 Å, the distance between HYR2 and HYA may be 4.36 Å, the distance between HYR2 and HBA may be 4.51 Å, the distance between HYA and HBA may be 3.57 Å, or a combination thereof.

In some embodiments, the compound is not any of PH1-37 or tubulin polymerization inhibitors 1-7 (TPI1-7), and the compound is not of Formula V. In other embodiments, the compound is not any of PH1-37 or tubulin polymerization inhibitors 1-7 (TPI1-7), and the compound is not of Formula I or V.

Hypo1 was used as a query to screen a subset of a database containing 350,000 compounds and yielded 500 compounds with fitness values above 3.5 out of a maximum of 4.0. Among the 500 compounds are structurally novel small-molecule compounds PH1-37.

| Compound | Structure | Hypo1 Fit Value |
|---|---|---|
| PH1 | 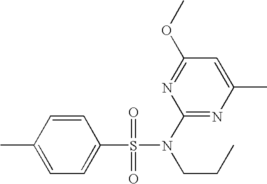 | 3.81 |
| PH2 | 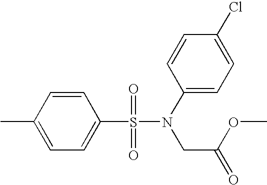 | 3.79 |
| PH3 | 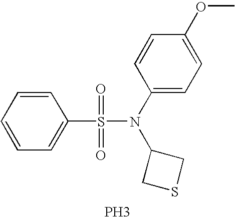 | 3.79 |
| PH4 | 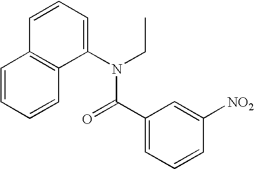 | 3.80 |
| PH5 | 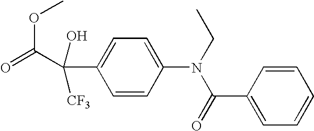 | 3.73 |
| PH6 | 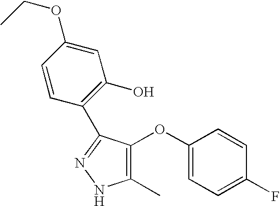 | 3.75 |
| PH7 | 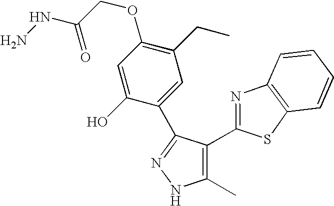 | 3.59 |
| PH8 | 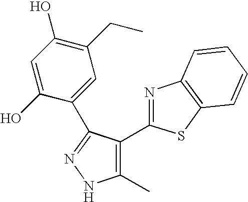 | 3.56 |
| PH9 | 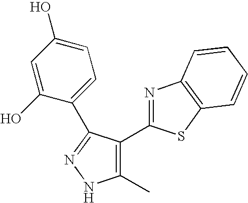 | 3.56 |
| PH10 | 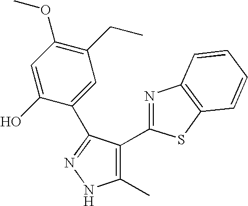 | 3.54 |
| PH11 | 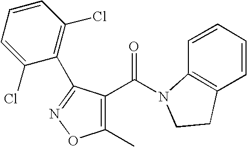 | 3.57 |
| PH12 | 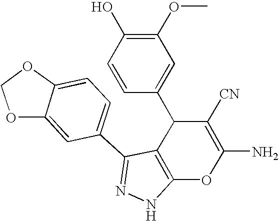 | 3.73 |
| PH13 | 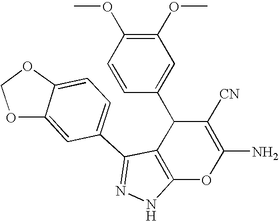 | 3.71 |
| PH14 | 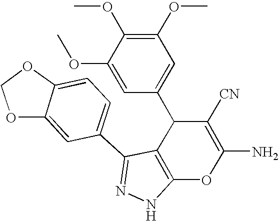 | 3.69 |
| PH15 | 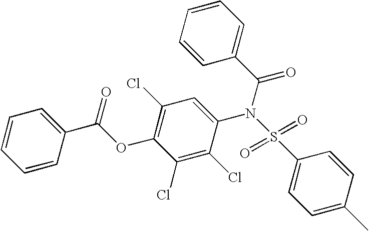 | 3.69 |
| PH16 | 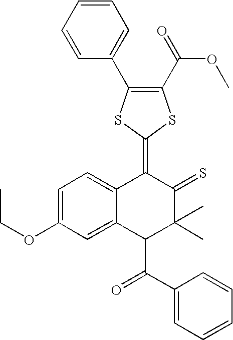 | 3.68 |
| PH17 | 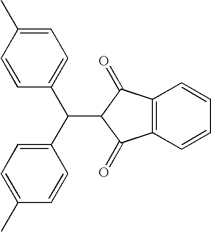 | 3.67 |
| PH18 | 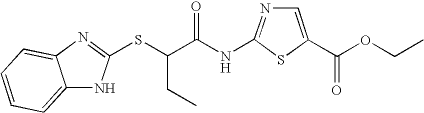 | 3.66 |
| PH19 | 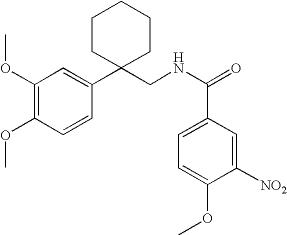 | 3.65 |
| PH20 | 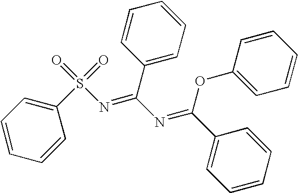 | 3.64 |
| PH21 | 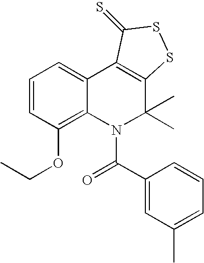 | 3.63 |
| PH22 | 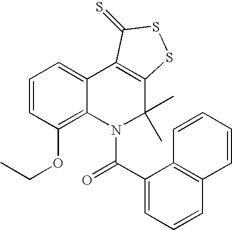 | 3.63 |
| PH23 | 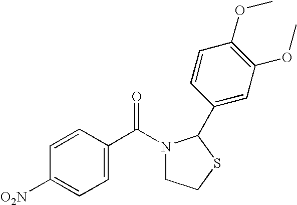 | 3.63 |
| PH24 | 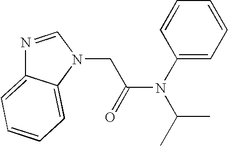 | 3.62 |
| PH25 | 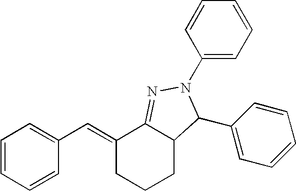 | 3.60 |
| PH26 | 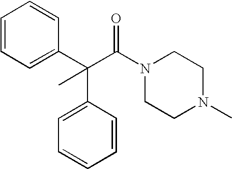 | 3.60 |
| PH27 | 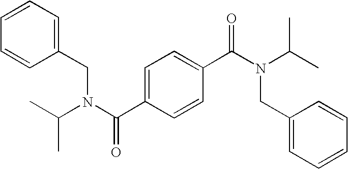 | 3.60 |
| PH28 | 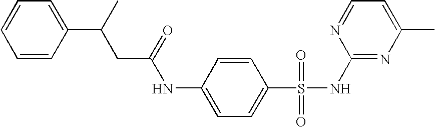 | 3.57 |
| PH29 | 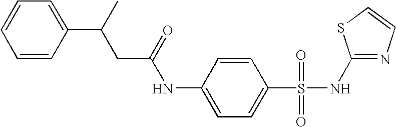 | 3.57 |
| PH30 | 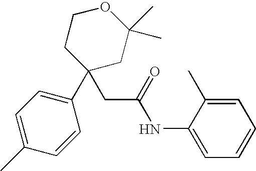 | 3.54 |
| PH31 | 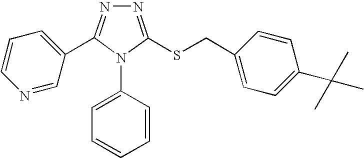 | 3.53 |
| PH32 | 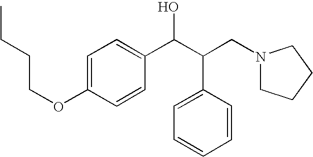 | 3.52 |
| PH33 | 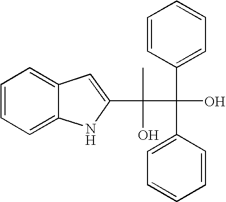 | 3.50 |
| PH34 | 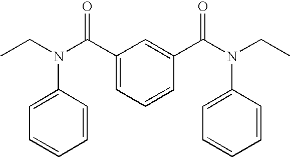 | 3.55 |
| PH35 | 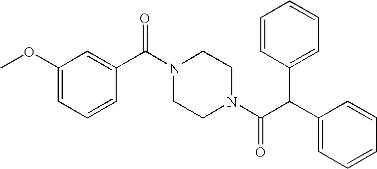 | 3.52 |
| PH36 | 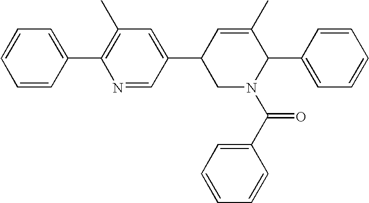 | 3.52 |
| PH37 | 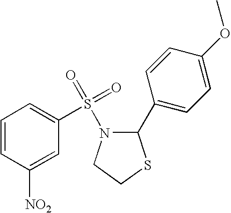 | 3.50 |

Accordingly, in some embodiments, a compound of the invention has a Hypo1 fitness value of above 3.5.

The known TPIs were mapped onto Hypo1 with a fitness value of less than 2.7.

| | | |
|---|---|---|
| | | Hy- |
| | | po1 |
| Com- | | Fit |
| pound | Structure | Value |

| | | |
|---|---|---|
| TPI1 | 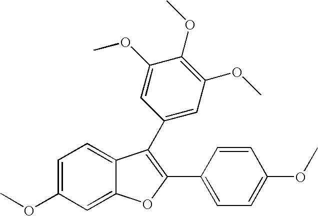 | 2.54 |
| TPI2 | 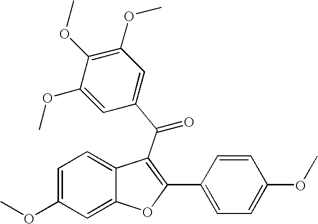 | 2.50 |
| TPI3 | 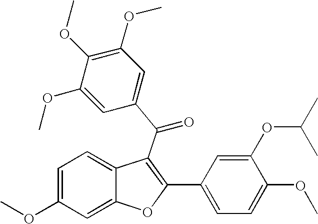 | 2.52 |
| TPI4 | 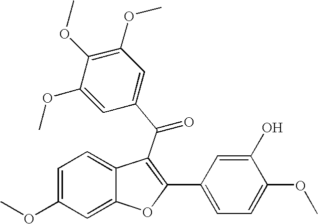 | 2.65 |
| TPI5 | 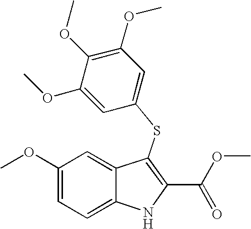 | 1.76 |
| TPI6 | 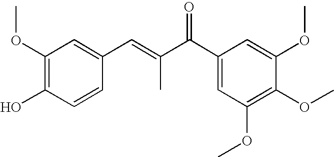 | 0.60 |

Reference for TPI1-4: Flynn et al., 2002, J. Med. Chem. 45:2670-2673; reference for TPI5-6: Nguyen et al., 2005, J. Med. Chem. 48:6107-6116.

A compound of the invention may be of a formula selected from the group consisting of Formulas I, Ia-c, II, IIa-c, III, IIIa-c, IV, and IVa-c or the group consisting of Formulas II, IIa-c, III, IIIa-c, IV, and IVa-c.

R₁-R₇ taken independently or together are a hydrogen atom, a halogen atom, a hydroxyl group, or any other organic groups containing any number of carbon atoms, preferably 1-20 carbon atoms and optionally include a heteroatom such as oxygen, sulfur, or nitrogen, in a linear, branched or cyclic structural format. X and Z taken independently or together are a heteroatom such as oxygen, sulfur, or nitrogen.

A compound of the invention may include both unsubstituted and substituted moieties. The term “unsubstituted” refers to a moiety having each atom hydrogenated such that the valency of each atom is filled. The term “substituted” refers to moieties having one, two, three, or more substituents, which may be the same or different, each replacing a hydrogen atom.

Representative R₁-R₇ groups include (not limited to) alkyl, substituted alkyl, alkenyl, substituted alkenyl, alkynyl, substituted alkynyl, phenyl, substituted phenyl, aryl, substituted aryl, heteroaryl, and substituted heteroaryl. Representative substitutions include (not limited to) halo, hydroxyl, alkoxy, alkylthio, phenoxy, aryoxy, cyano, isocyano, carbonyl, carboxyl, amino, amido, sulfonyl, and substituted heterocyclics.

CT10-16 and 19 are exemplary compounds of Formula I, CT20 is an exemplary compound of Formula II, CT21-22 are exemplary compounds of Formula III, and CT23 is an exemplary compound of Formula V.

Protected forms of the compounds are included within the scope of the invention. An reactive moiety is “protected” when it is temporarily and chemically transformed such that it does not react under conditions where the non-protected moiety reacts. For example, trimethylsilylation is a typical transformation used to protect reactive functional groups such as hydroxyl or amino groups from their reaction with growing anionic species in anionic polymerization.

In general, the species of protecting group is not critical, provided that it is stable under the conditions of any subsequent reactions on other positions of the compound and can be removed at an appropriate point without adversely affecting the remainder of the molecule. In addition, one protecting group may be substituted for another after the substantive synthetic transformations are complete. Examples and conditions for the attachment and removal of various protecting groups are found in Greene, Protective Groups in Organic Chemistry, 1st ed., 1981, and 2nd ed., 1991.

In addition, salts, solvates, and hydrates of the compounds are within the scope of the invention. For example, a salt can be formed between a positively charged amino substituent and a negatively charged counterion.

A compound of Formula I or II may be synthesized according to Scheme 1. Briefly, homoallylic alcohols 2 obtained in this reaction are useful due to the presence of multiple functionalities in close proximity. Several homoallylic alcohols 2 may be synthesized using the one pot cross coupling/allylboration reaction (Scheme 1), and then treated with CBr₄ and PPh₃ at room temperature. trans-α-Methylene-c-lactones 3 may be produced in moderate to good yields. Lactonization of homoallylic alcohols 2 using p-toluenesulfonic acid can produce the expected cis-α-methylene-c-lactones 3 in isolated yields ranging from 94% to 99%.

General experimental procedure for synthesis of trans-α-methylenelactones 3 (Scheme 1): Homoallylic alcohol 2 (1 mmol) is dissolved in dichloromethane (5 mL) and the solution cooled to 0° C. Carbon tetrabromide (1.5 mmol) and triphenylphosphene (1.5 mmol) are added sequentially, and the reaction mixture stirred at room temperature overnight under a nitrogen atmosphere (reaction monitored by TLC). After completion of the reaction, the solvent is removed and the product isolated by column chromatography.

General experimental procedure for synthesis of cis-α-methylene-lactones 3 (Scheme 1): Homoallylic alcohol 2 (1 mmol) is dissolved in dichloromethane (5 mL) and the solution cooled to 0° C. p-Toluenesulfonic acid (0.1 mmol) is added, and the reaction mixture stirred at room temperature overnight under a nitrogen atmosphere (reaction monitored by TLC). After completion of the reaction, the solvent is removed and the product is isolated by column chromatography.

A compound of Formula III or IV may be synthesized according to Scheme 2. Briefly, Baylis-Hillman acetate adduct 1 (1 mmol) and bis(pinacolato)diboron 2 (1.1 mmol) are dissolved in toluene. A palladium catalyst (3 mol %) is then added and the mixture stirred for 3 h under a nitrogen atmosphere at 50° C. After cooling to 0° C., an aldehyde (1.2 mmol) and silica supported BF₃ catalyst (100 mg) are added and the mixture stirred at room temperature for the indicated time. The mixture is then filtered to remove the solid catalyst. The filtrate is concentrated under reduced pressure and homoallylic alcohol 3 isolated by silica gel chromatography using hexane/ethyl acetate as an elute. Several reactions may be carried out using Baylis-Hillman adducts 1 derived from reactions of aromatic, heteroaromatic, and aliphatic aldehydes with p-nitrobenzaldehyde. Baylis-Hillman adducts derived from aromatic aldehydes can give very high yields of the corresponding homoallylic alcohols 3.

A compound of Formula V may be prepared using a general synthetic method shown in Scheme 3. 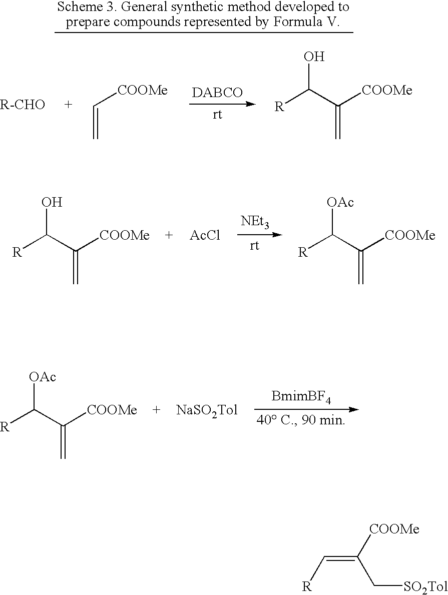
Compositions

The invention further provides a composition containing a compound of the invention, or a pharmaceutically acceptable salt, solvate, or hydrate thereof, and a pharmaceutically acceptable carrier. In some embodiments, the composition includes a pharmaceutically acceptable carrier and a compound selected from the group consisting of PH1-37 and compounds of Formula V.

“Pharmaceutically acceptable carriers” include solvents, dispersion media, coatings, antibacterial and antifungal agents, isotonic and absorption delaying agents, and the like, compatible with pharmaceutical administration.

A composition of the invention is formulated to be compatible with its intended route of administration. See, e.g., U.S. Pat. No. 6,756,196. Examples of routes of administration include parenteral, e.g., intravenous, intradermal, subcutaneous, oral (e.g., inhalation), transdermal (topical), transmucosal, and rectal administration. Solutions or suspensions used for parenteral, intradermal, or subcutaneous application can include the following components: a sterile diluent such as water for injection, saline solution, fixed oils, polyethylene glycols, glycerine, propylene glycol or other synthetic solvents; antibacterial agents such as benzyl alcohol or methyl parabens; antioxidants such as ascorbic acid or sodium bisulfite; chelating agents such as ethylenediaminetetraacetic acid; buffers such as acetates, citrates or phosphates; and agents for the adjustment of tonicity such as sodium chloride or dextrose. pH can be adjusted with acids or bases, such as hydrochloric acid or sodium hydroxide. The parenteral preparation can be enclosed in ampoules, disposable syringes or multiple dose vials made of glass or plastic.

Compositions suitable for injectable use include sterile aqueous solutions (where water soluble) or dispersions and sterile powders for the extemporaneous preparation of sterile injectable solutions or dispersion. For intravenous administration, suitable carriers include physiological saline, sterile water, Cremophor EL™ (BASF, Parsippany, N.J.), or phosphate buffered saline (PBS). In all cases, the composition must be sterile and should be fluid to the extent that easy syringability exists. It should be stable under the conditions of manufacture and storage and must be preserved against the contaminating action of microorganisms such as bacteria and fungi. The carrier can be a solvent or dispersion medium containing, for example, water, ethanol, polyol (for example, glycerol, propylene glycol, and liquid polyetheylene glycol, and the like), or suitable mixtures thereof. The proper fluidity can be maintained, for example, by the use of a coating such as lecithin, by the maintenance of the required particle size in the case of dispersion and by the use of surfactants. Prevention of the action of microorganisms can be achieved by various antibacterial and antifungal agents, for example, parabens, chlorobutanol, phenol, ascorbic acid, thimerosal, and the like. In many cases, it will be preferable to include isotonic agents, for example, sugars, polyalcohols such as manitol, sorbitol, or sodium chloride in the composition. Prolonged absorption of the injectable compositions can be brought about by including in the composition an agent which delays absorption, for example, aluminum monostearate and gelatin.

Sterile injectable solutions can be prepared by incorporating the compounds in the required amounts in an appropriate solvent with one or a combination of ingredients enumerated above, as required, followed by filtered sterilization. Generally, dispersions are prepared by incorporating the compounds into a sterile vehicle which contains a basic dispersion medium and the required other ingredients from those enumerated above. In the case of sterile powders for the preparation of sterile injectable solutions, the preferred methods of preparation are vacuum drying and freeze-drying which yields a powder of the active ingredient plus any additional desired ingredient from a previously sterile-filtered solution thereof.

Oral compositions generally include an inert diluent or an edible carrier. For the purpose of oral therapeutic administration, the compounds can be incorporated with excipients and used in the form of tablets, troches, or capsules, e.g., gelatin capsules. Oral compositions can also be prepared using a fluid carrier for use as a mouthwash. Pharmaceutically compatible binding agents, and/or adjuvant materials can be included as part of the composition. The tablets, pills, capsules, troches, and the like can contain any of the following ingredients, or compounds of a similar nature: a binder such as microcrystalline cellulose, gum tragacanth or gelatin; an excipient such as starch or lactose, a disintegrating agent such as alginic acid, Primogel, or corn starch; a lubricant such as magnesium stearate or sterotes; a glidant such as colloidal silicon dioxide; a sweetening agent such as sucrose or saccharin; or a flavoring agent such as peppermint, methyl salicylate, or orange flavoring.

For administration by inhalation, the compositions are delivered in the form of an aerosol spray from pressured container or dispenser which contains a suitable propellant, e.g., a gas such as carbon dioxide or a nebulizer.

Systemic administration can also be by transmucosal or transdermal means. For transmucosal or transdermal administration, penetrants appropriate to the barrier to be permeated are used in the formulation. Such penetrants are generally known in the art, and include, for example, for transmucosal administration, detergents, bile salts, and fusidic acid derivatives. Transmucosal administration can be accomplished through the use of nasal sprays or suppositories. For transdermal administration, the compounds are formulated into ointments, salves, gels, or creams as generally known in the art.

The compositions of the invention can also be prepared in the form of suppositories (e.g., with conventional suppository bases such as cocoa butter and other glycerides) or retention enemas for rectal delivery.

In one embodiment, the compositions are prepared with carriers that will protect the compounds against rapid elimination from the body, such as a controlled release formulation, including implants and microencapsulated delivery systems. Biodegradable, biocompatible polymers can be used, such as ethylene vinyl acetate, polyanhydrides, polyglycolic acid, collagen, polyorthoesters, and polylactic acid. Methods for preparation of such formulations will be apparent to those skilled in the art. The materials can also be obtained commercially from Alza Corporation and Nova Pharmaceuticals, Inc. Liposomal suspensions (including liposomes targeted to infected cells with monoclonal antibodies to viral antigens) can also be used as pharmaceutically or cosmeceutically acceptable carriers. These can be prepared according to methods known to those skilled in the art, for example, as described in U.S. Pat. No. 4,522,811.

It is advantageous to formulate oral or parenteral compositions in dosage unit form for ease of administration and uniformity of dosage. “Dosage unit form,” as used herein, refers to physically discrete units suited as unitary dosages for the subject to be treated; each unit containing a predetermined quantity of active compound calculated to produce the desired therapeutic or cosmeceutic effect in association with the required pharmaceutical carrier.

The compositions of the invention can be included in a container, pack, or dispenser together with instructions for administration to form packaged products. Other active compounds can also be incorporated into the compositions.

Uses of Compounds and Compositions

The compounds and compositions described above can be use to bind tubulin, prevent tubulin polymerization, inhibit cell growth, arrest cell cycle, cause cell death, and treat cancer and abnormal cell proliferation disorders.

Accordingly, one object of the invention is to provide a method of binding tubulin to a compound of the invention in vitro or in vivo, thereby preventing tubulin from polymerization. The method involves contacting tubulin with a composition of the invention or a compound of the invention or its pharmaceutically acceptable salt, solvate, or hydrate. In some embodiments, the compound is not any of TPI1-7. The compound may be selected from the group consisting of PH1-37 and compounds of Formula V. In some embodiments, the compound is selected from the group consisting of CT10-16 and 19-23.

Another object of the invention pertains to methods of modulating cell growth, cell cycle, or cell death for therapeutic purposes. These methods involve contacting a cell with a composition of the invention or a compound of the invention or its a pharmaceutically acceptable salt, solvate, or hydrate. In some embodiments, the compound is not any of TPI1-7. The compound may be selected from the group consisting of PH1-37 and compounds of Formula V. In some embodiments, the compound is selected from the group consisting of CT10-16 and 19-23. Methods for measuring cell growth, cell cycle, and cell death are known in the art. Several such methods are provided in the Examples below.

The modulatory methods of the invention may be performed in vitro, e.g., by culturing the cell with the composition or the compound or its pharmaceutically acceptable salt, solvate, or hydrate. In some embodiments, the cell may be a cancer cell (e.g., a colon cancer cell, breast cancer cell, lung cancer cell, ovarian cancer cell, brain cancer cell, prostate cancer cell, leukemia cell, or lymphoma cell) or a cell associated with an abnormal cell proliferation disorder (e.g., angiogenesis disorder, immune mediated or non-immune mediated inflammatory disease, arthritis, age-related macular degeneration, or diabetes).

Alternatively, the modulatory methods of the invention may be performed in vivo, e.g., by administering the composition or the compound or its pharmaceutically acceptable salt, solvate, or hydrate to a subject such as a subject suffering from cancer or an abnormal cell proliferation disorder. As such, the present invention provides methods for treating a subject afflicted with a disease or disorder characterized by aberrant or unwanted cell growth and/or proliferation.

“Subject,” as used herein, refers to a human or animal, including all vertebrates, e.g., mammals, such as primates (particularly higher primates), sheep, dog, rodents (e.g., mouse or rat), guinea pig, goat, pig, cat, rabbit, cow; and non-mammals, such as chicken, amphibians, reptiles, etc. In a preferred embodiment, the subject is a human. In another embodiment, the subject is an animal.

A subject to be treated may be identified, e.g., using diagnostic methods known in the art, as being suffering from a disease such as cancer or an abnormal cell proliferation disorder. The subject may be identified in the judgment of a subject or a health care professional, and can be subjective (e.g., opinion) or objective (e.g., measurable by a test or diagnostic method).

As used herein, the term “treatment” is defined as the application or administration of a therapeutic agent to a subject, or application or administration of a therapeutic agent to an isolated tissue or cell line from a subject, who has a disease, a symptom of disease, with the purpose to cure, heal, alleviate, relieve, alter, remedy, ameliorate, improve or affect the disease, the symptoms of disease.

The therapeutic agent is administered in an “effective amount,” i.e., an amount that is capable of producing a medically desirable result as delineated above in a treated subject. The medically desirable result may be objective (i.e., measurable by some test or marker) or subjective (i.e., subject gives an indication of or feels an effect).

Toxicity and therapeutic efficacy of a compound of the invention can be determined by standard pharmaceutical procedures in cell cultures or experimental animals, e.g., for determining the LD₅₀ (the dose lethal to 50% of the population) and the ED₅₀ (the dose therapeutically effective in 50% of the population). The dose ratio between toxic and therapeutic effects is the therapeutic index, and can be expressed as the ratio of LD₅₀/ED₅₀. Compounds which exhibit high therapeutic indices are preferred. While compounds that exhibit toxic side effects may be used, care should be taken to design a delivery system that targets such compounds to the site of affected tissue in order to minimize potential damage to uninfected cells and, thereby, reduce side effects.

A therapeutically effective amount of the compounds (i.e., an effective dosage) may range from, e.g., about 1 microgram per kilogram to about 500 milligrams per kilogram, about 1 micrograms per kilogram to about 100 milligrams per kilogram, or about 1 microgram per kilogram to about 50 micrograms per kilogram. The compounds can be administered, e.g., one time per week for between about 1 to 10 weeks, preferably between 2 to 8 weeks, more preferably between about 3 to 7 weeks, and even more preferably for about 4, 5, or 6 weeks. It is furthermore understood that appropriate doses of a compound depend upon the potency of the compound. When one or more of these compounds is to be administered to a subject (e.g., an animal or a human), a physician, veterinarian, or researcher may, for example, prescribe a relatively low dose at first, subsequently increasing the dose until an appropriate response is obtained. In addition, it is understood that the specific dose level for any particular subject will depend upon a variety of factors including the activity of the specific compound employed, the age, body weight, general health, gender, and diet of the subject, the time of administration, the route of administration, the rate of excretion, any drug combination, the severity of the disease or disorder, previous treatments, and other diseases present. Moreover, treatment of a subject with a therapeutically effective amount of the compounds can include a single treatment or, preferably, a series of treatments.

Screening Methods

Another object of the invention is to provide a method for identifying therapeutic compounds, i.e., compounds that can be used to bind tubulin, prevent tubulin polymerization, inhibit cell growth, arrest cell cycle, cause cell death, or treat cancer or abnormal cell proliferation disorders. Accordingly, the invention provides a computer-readable medium containing a representation of a pharmacophore, wherein the pharmacophore includes features of a first hydrophobic aromatic group (HYR1), a second hydrophobic aromatic group (HYR2), a hydrophobic group (HYA), and an H-bond acceptor (HBA). HYR1, HYR2, HYA, and HBA are configured according to FIG. 1(a). The distance between HYR1 and HYR2 is 4.37±1 Å, the distance between HYR1 and HYA is 6.29±1 Å, the distance between HYR1 and HBA is 3.72±1 Å, the distance between HYR2 and HYA is 4.36±1 Å, the distance between HYR2 and HBA is 4.51±1 Å, and the distance between HYA and HBA is 3.57±1 Å.

In some embodiments, the distance between HYR1 and HYR2 may be 4.37 Å, the distance between HYR1 and HYA may be 6.29 Å, the distance between HYR1 and HBA may be 3.72 Å, the distance between HYR2 and HYA may be 4.36 Å, the distance between HYR2 and HBA may be 4.51 Å, the distance between HYA and HBA may be 3.57 Å, or a combination thereof.

As used herein, “computer readable medium” refers to any medium that can be read and accessed directly by a computer. Such media include, but are not limited to, magnetic storage media, such as floppy discs, hard disc storage media, and magnetic tapes; optical storage media such as CD-ROM; electrical storage media such as RAM and ROM; and hybrids of these categories such as magnetic/optical storage media. A skilled artisan can readily create a computer readable medium having recorded thereon a representation of a pharmacophore described above using any of the methods well known in the art.

By providing a representation of a pharmacophore described above in computer readable form, a skilled artisan can routinely access the pharmacophore information for a variety of purposes. For example, one skilled in the art can use a pharmacophore described above in computer readable form to compare with compound information stored within data storage means. Search means can be used to identify compounds that match the features of the pharmacophore and therefore are candidate therapeutic molecules.

Accordingly, the invention provides a method for identifying a therapeutic small molecule. The method involves comparing the three-dimensional structure of a test compound with the three-dimensional structure of a pharmacophore described above, and selecting the test compound if the test compound conforms to the features of the pharmacophore. The test compounds so identified are within the scope of the invention.

The following examples are intended to illustrate, but not to limit, the scope of the invention. While such examples are typical of those that might be used, other procedures known to those skilled in the art may alternatively be utilized. Indeed, those of ordinary skill in the art can readily envision and produce further embodiments, based on the teachings herein, without undue experimentation.

### EXAMPLES

### Example I—Synthesis of Representative Compounds of Formulas I-V

### 1. Synthesis of CT13 ((4S,5R)-3-methylene-4,5-diphenyl-dihydrofuran-2(3H)-one)

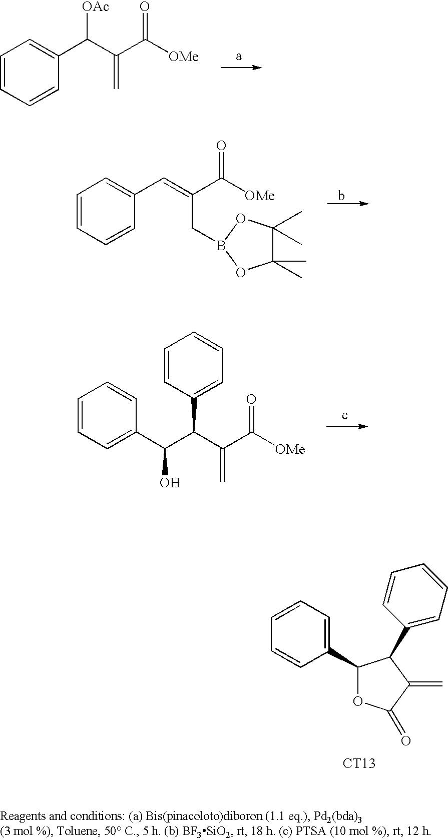

Baylis-Hillman acetate was reacted with bis(pinacoloto)diboron in the presence of palladium catalyst at 50° C. for about 4 h to provide 3-phenyl-2-methoxycarbonyl allylboronate, which reacted with benzaldehyde in the presence of silica-supported borontrifluoride catalyst to obtain corresponding homoallylic alcohol in high yields. Resulted homoallylic alcohol was treated with mild acidic conditions (PTSA, CH₂Cl₂) to provide lactone (CT13).

### 2. Synthesis of CT14 ((4S,5R)-3-methylene-4,5-diphenyl-dihydrofuran-2(3H)-one)

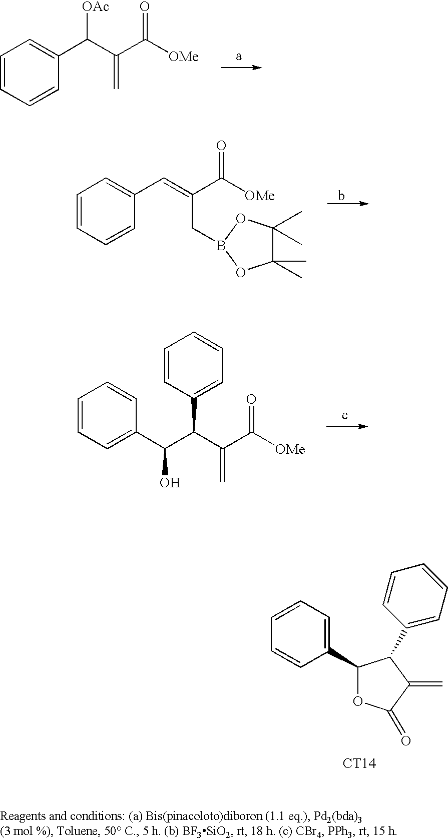

Baylis-Hillman acetate was reacted with bis(pinacoloto)diboron in the presence of palladium catalyst at 50° C. for about 4 h to provide 3-phenyl-2-methoxycarbonyl allylboronate, which reacted with benzaldehyde in the presence of silica-supported borontrifluoride catalyst to obtain corresponding homoallylic alcohol in high yields. Treatment of resulted homoallylic alcohols with brominating reagent carbon tetrabromide and triphenylphosphene at room temperature for overnight under nitrogen atmosphere produced trans-α-methylene-γ-lactone CT14.

### 3. Synthesis of CT19

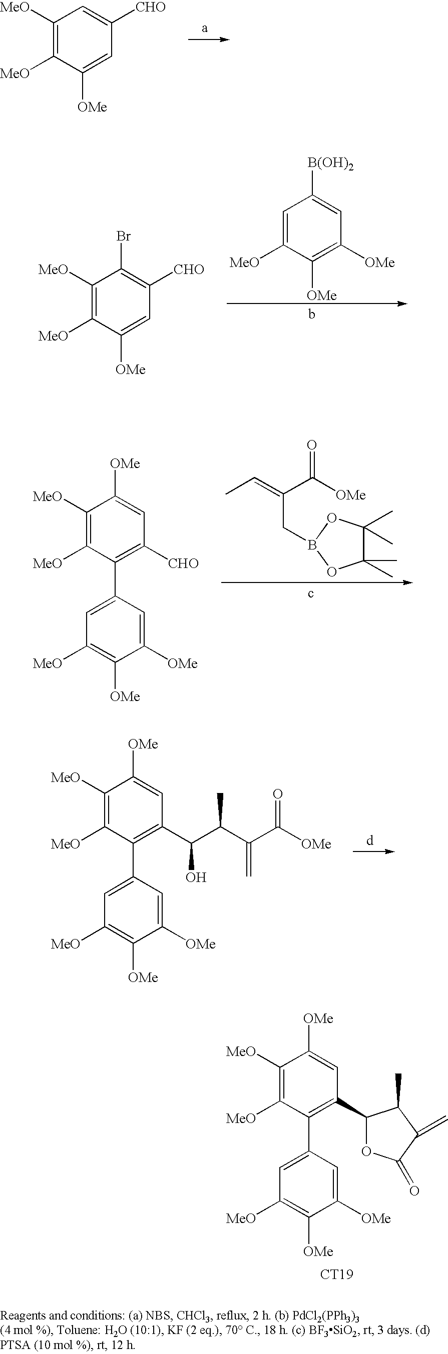

The synthesis began with the reaction of arylboronic acid and 2-bromo-3,4,5-trimethoxy benzaldehyde in the presence of 4 mol % of PdCl₂(PPh₃)₃ catalyst. The cross-coupling was achieved without using external ligand and KF was used as base in aqueous toluene solvent at 70° C. for 18 h to obtain biaryl aldehyde in high yields. The eupomatilone's (CT19) lactone ring was constructed by the addition of 3-methyl-2-methoxycarbonyl allylboronate to the biaryl aldehyde. The allylboronate was prepared following the method for the reaction of Baylis-Hillman acetate adduct and bis(pinacoloto)diboron. Since the allylboronates are moisture sensitive and difficult to purify on column chromatography, without isolation of allylboronate from the reaction mixture, aldehyde was added to obtain homoallylic alcohol. Cyclization of alcohol was achieved under mild acidic conditions (PTSA, CH₂CL₂) to obtain compound CT19. See Kabalka and Venkataiah, 2005, Tetrahedron Letters 46:7325-28.

### 4. Synthesis of CT21 ((3S,4R)-methyl 4-(4-cyanophenyl)-4-hydroxy-2-methylene-3-phenylbutanoate)

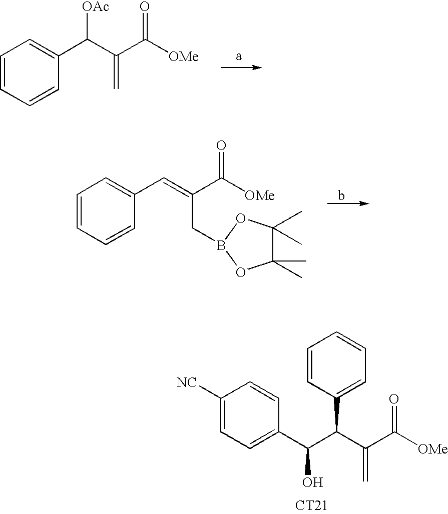 Reagents and conditions: (a) Bis(pinacoloto)diboron (1.1 eq.), Pd₂(dba)₃ (3 mol %), Toluene, 50° C., 5 h. (b) BF₃.SiO₂, rt, 1 day.

Baylis-Hillman acetate was reacted with bis(pinacoloto)diboron in the presence of palladium catalyst at 50° C. for about 4 h to provide 3-phenyl-2-methoxycarbonyl allylboronate, which reacted with 4-cyanobenzaldehyde in the presence of silica-supported borontrifluoride catalyst to obtain corresponding homoallylic alcohol CT21 in high yields.

### 5. Synthesis of CT23 ((Z)-methyl 3-phenyl-2-(tosylmethyl)acrylate)

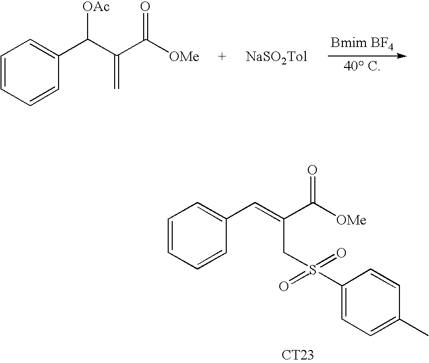

Reaction of NaSO₂ToI and Baylis-Hillman acetate adducts in the presence of ionic liquids such as butylmethylimidazolium tetrafluoroborate at 40° C. for 1.5 h proceeded smoothly and allylsulphone CT23 was observed in high yields through SN2′ substitution reaction. Reaction is very general and can be used to prepare numerous substituents on aromatic ring and allow synthesis of a number of sulphone molecules.

### Example II—Biological Activities of Compounds of Formulas I-V in Cell Lines

Anticancer activities and cell cycle perturbations induced by a number of representative compounds have been evaluated using MTT and cell cycle analysis assays.

MTT Assay:

The cytotoxicity of the several representative compounds have been evaluated using MTT assay. Briefly, cells were seeded in 96-well microtiter plates (HCT16 p53+/+ (wild type), HCTp53−/− (p53 negative) colon cancer cells and MD-MBA-435 (p53 mutant) breast cancer cells at 4,000 cells/well) and allowed to attach. Cells were subsequently treated with a continuous exposure to the corresponding drug for 72 hours. A 3-(4,5-dimethylthiazol-2-yl)-2,5-diphenyltetrazolium bromide solution (at a final concentration of 0.5 mg/mL) was added to each well, and cells were incubated for 4 hours at 37° C. After removal of the medium, DMSO was added and the absorbance was read at 570 nm. All assays were done in triplicate. The IC₅₀ was then determined for each drug from a plot of log (drug concentration) versus percentage of cell kill.

Cell Cycle Analysis:

Cell cycle perturbations induced by the representative compounds were analyzed by propidium iodide DNA staining. Briefly, exponentially growing cells were treated with different doses of the drug for 24, 48, and 72 hours. At the end of each treatment time, cells were collected and washed with PBS after a gentle centrifugation at 200×g for 5 minutes. Cells were thoroughly resuspended in 0.5 mL of PBS and fixed in 70% ethanol for at least 2 hours at 4° C. Ethanol-suspended cells were then centrifuged at 200×g for 5 minutes and washed twice in PBS to remove residual ethanol. For cell cycle analysis, the pellets were suspended in 1 mL of PBS containing 0.02 mg/mL of propidiumiodide, 0.5 mg/mL of DNase-free RNase A and 0.1% of Triton X-100 and incubated at 37° C. for 30 minutes. Cell cycle profiles were obtained using a FACScan flowcytometer (Becton Dickinson, San Jose, Calif.) and data were analyzed by ModFit LT software (Verity Software House, Inc., Topsham, Me.).

1. Anticancer Activities of Representative Compounds of Formulas I-II

The representative compounds (CT10-16 and 19-20) showed excellent anticancer activities in a panel of human cancer cell lines. The structures and cell growth inhibitory activities of the compounds are given in Table 1.

TABLE 1
Structures and anticancer activities of representative compounds of Formulas I-II.

| | | Anticancer Activity (IC₅₀, μM) | | | | | |
|---|---|---|---|---|---|---|---|
| Cmpd | Structure | 1^{a} | 2^{b} | 3^{c} | 4^{d} | 5^{e} | 6^{f} |
| CT10 | 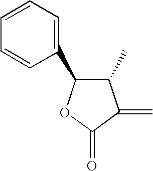 | 23 ± 2 | 1 ± 1 | 5 ± 3 | | | |
| CT11 | 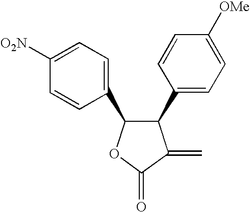 | 9 ± 5 | 2 ± 1 | 2 ± 2 | 3 | | |
| CT12 | 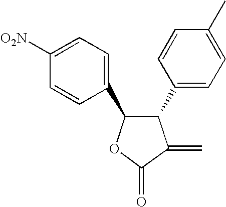 | 7 ± 5 | 4 ± 1 | 3 ± 2 | 6 | | |
| CT13 | 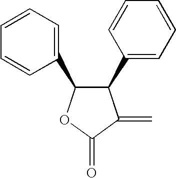 | 11 ± 2 | 3 ± 3 | 2 ± 2 | | | |
| CT14 | 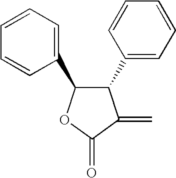 | 8 ± 1 | 2 ± 1 | 2 ± 2 | 2 | 2 | 1 |
| CT15 | 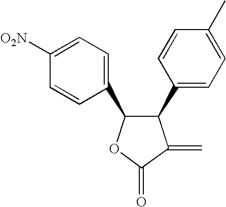 | >20 | >20 | >20 | | | |
| CT16 | 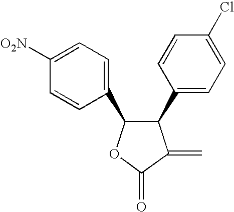 | 18 ± 1 | 4 ± 2 | 3 ± 2 | <1 | | |
| CT19 | 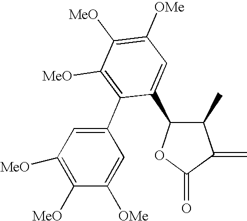 | 4 | 1 ± 1 | 5 | 4 | | |
| CT20 | 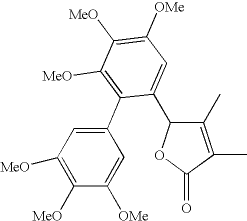 | >20 | 3 | >20 | >20 | | |

^{a}HCTp53−/− (p53 negative) colon cancer cells,
^{b}HCT1G p53+/+ (wild type) colon cancer cells,
^{c}MD-MBA-435 (p53 mutant) breast cancer cells,
^{d}MCF7 breast cells,
^{e}NIH3T3 mouse fibroblast cells, and
^{f}NIH 189 mouse fibroblast cells.

A representative compound, CT14 is considered for cell cycle analysis to evaluate its effect on cell cycle. CT14 showed approximately 75% G2/M arrest of HCT116p53+/+ at 1 μM (Table 2).

TABLE 2
Cell cycle analysis for HCT116p53+/+ cells
after treatment with 1 μM of CT14.

| | % | | |
|---|---|---|---|
| | control | after 12 h | after 24 h |
| G0/G1 | 63.9 | 11.9 | 12.6 |
| S | 14.3 | 12.4 | 12.8 |
| G2/M | 21.6 | 75.8 | 74.5 |

2. Anticancer Activities of Representative Compounds of Formulas III-IV

Two representative compounds (CT21-22) were evaluated for their anticancer activities. These compounds showed significant cell kill in a panel of human cancer cell lines at low micromolar concentrations. The structures and cell growth inhibitory activities of the compounds are given in Table 3.

TABLE 3
Structures and anticancer activities of representative compounds of Formulas III-IV.

| | | Anticancer Activity (IC₅₀, μM) | | | | | |
|---|---|---|---|---|---|---|---|
| Cmpd | Structure | 1^{a} | 2^{b} | 3^{c} | 4^{d} | 5^{e} | 6^{f} |
| CT21 | 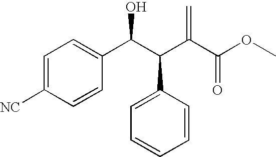 | 13 ± 2 | 2 ± 1 | 8 ± 2 | 3 | | |
| CT22 | 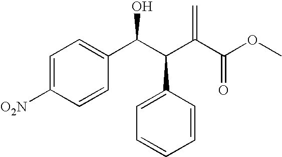 | 12 ± 4 | 1 ± 1 | 7 ± 5 | 3 | 3.5 | 3 |

^{a}HCTp53−/− (p53 negative) colon cancer cells,
^{b}HCT16 p53+/+ (wild type) colon cancer cells,
^{c}MD-MBA-435 (p53 mutant) breast cancer cells,
^{d}MCF7 breast cells,
^{e}NIH3T3 mouse fibroblast cells, and
^{f}NIH 189 mouse fibroblast cells.

3. Anticancer Activities of Representative Compound of Formula V

Anticancer activities of a representative compound (CT23) in a panel of human cancer cell lines were evaluated. Compound CT23 showed potent anticancer activity at low micromolar concentration. The structure and anticancer activities of CT23 are given in Table 4.

TABLE 4
Structure and anticancer activities of a representative compound of Formula V.

| | | Anticancer Activity (IC₅₀, μM) | | | | | |
|---|---|---|---|---|---|---|---|
| Cmpd | Structure | 1^{a} | 2^{b} | 3^{c} | 4^{d} | 5^{e} | 6^{f} |

| | | | | | |
|---|---|---|---|---|---|
| CT23 | 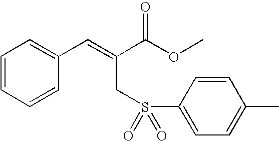 | 5 | 2 ± 2 | 6 ± 3 | 15 |

^{a}HCTp53−/− (p53 negative) colon cancer cells,
^{b}HCT16 p53+/+ (wild type) colon cancer cells,
^{c}MD-MBA-435 (p53 mutant) breast cancer cells,
^{d}MCF7 breast cells,
^{e}NIH3T3 mouse fibroblast cells, and
^{f}NIH 189 mouse fibroblast cells.

### Example III—Biological Activities of Compounds of Formulas I-V in Animals

Animals:

50 male athymic nude (nu/nu) mice (Charles River Laboratories, Wilmington, USA) were used for in vivo testing. The animals were fed ad libitum and kept in air-conditioned rooms at 20±2° C. with a 12 h light-dark period. Animal care and manipulation were in agreement with the University of Southern California (USC) institutional guidelines, which are in accordance with the Guidelines for the Care and Use of Laboratory Animals.

Drug Treatment of Tumor Xenografts:

MDA-MB-435 cells from in vitro cell culture were inoculated s.c. in both flanks of athymic nude mice (2×10⁶ cells/flank) under aseptic conditions. Tumor growth was assessed by biweekly measurement of tumor diameters with a Vernier caliper (length×width). Tumor weight was calculated according to the formula: TW (mg)=tumor volume (mm³)=d²×D/2, where d and D are the shortest and longest diameters, respectively. Cells were allowed to grow to an average volume of 100 mm³. Animals were then randomly assigned for control and treatment groups to receive control vehicle or CT19 (10 and 20 mg/kg, dissolved in sesame oil) via i.p. injections once a day for 5 days. Treatment of each animal was based on individual body weight. After 5-day treatment, the tumor volumes in each group were measured once a week for four weeks. Treated animals were checked daily for treatment toxicity/mortality.

Statistical Analysis:

Assays were set up in triplicates and the results were expressed as means±SD. Statistical analysis and P-value determination were done by two-tailed paired t test with a confidence interval of 95% for determination of the significance differences between treatment groups. P<0.05 were considered to be significant. ANOVA was used to test for significance among groups. The SAS statistical software package (SAS institute) was used for statistical analysis.

CT19 Shows In Vivo Efficacy in Mice Xenograft Models

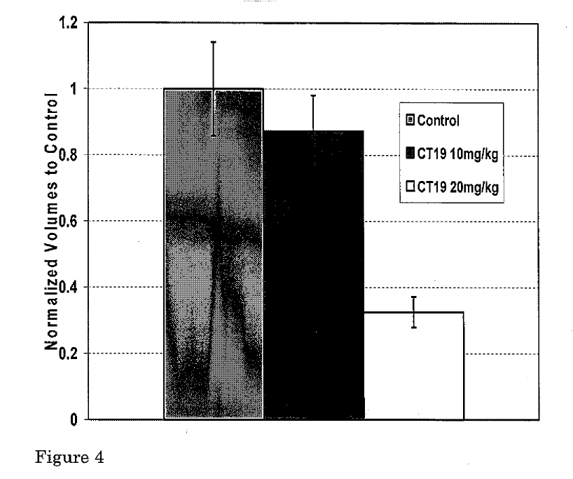

The in vivo efficacy of CT19 was evaluated in nude mice inoculated with human breast MDA-MB-435 cells. Animals were treated with a daily i.p. injections of saline (controls) and CT19 at 10 mg/kg or 20 mg/kg. After five-days of dosing, the drug treatment was discontinued and the animals were monitored biweekly for five weeks. CT19 significantly reduced tumor burden in breast xenografts (FIG. 4) without apparent toxicity. Treatment with CT19 was well tolerated and did not result in any drug-related deaths and changes in body weight.

All patents and articles cited herein are incorporated by reference in their entirety.

What is claimed is:

1. A compound, or a pharmaceutically acceptable salt, solvate, or hydrate thereof, wherein
the compound comprises a first hydrophobic aromatic group (HYR1), a second hydrophobic aromatic group (HYR2), a hydrophobic group (HYA), and an H-bond acceptor (HBA);
HYR1, HYR2, HYA, and HBA are configured according to FIG. 1(a), the distance between HYR1 and HYR2 is 4.37±1 Å, the distance between HYR1 and HYA is 6.29±1 Å, the distance between HYR1 and HBA is 3.72±1 Å, the distance between HYR2 and HYA is 4.36±1 Å, the distance between HYR2 and HBA is 4.51±1 Å, and the distance between HYA and HBA is 3.57±1 Å; and
the compound is not any of PH1-37 or tubulin polymerization inhibitors 1-7 (TPI1-7), and the compound is not of Formula V.

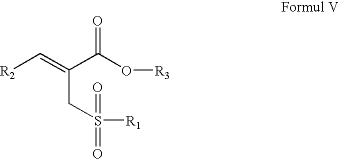

2. The compound of claim 1, wherein
the compound is of a formula selected from the group consisting of Formulas I, Ia-c, II, IIa-c, III, IIIa-c, IV, and IVa-c; 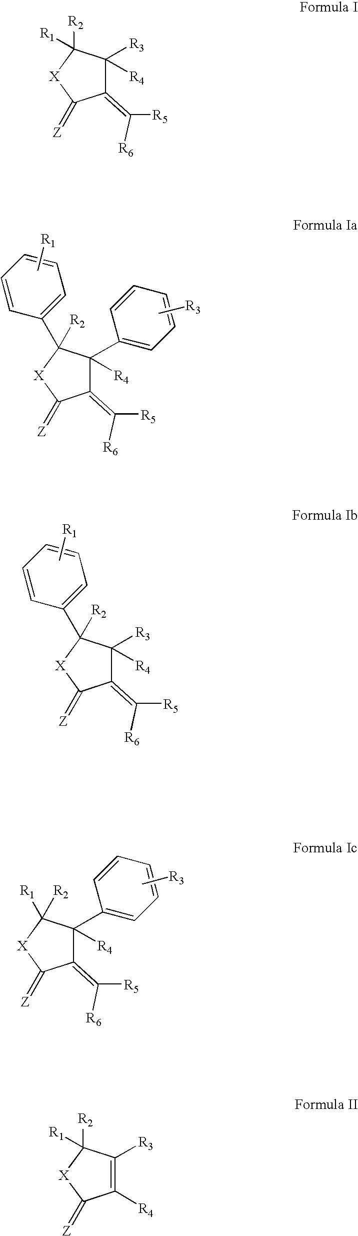 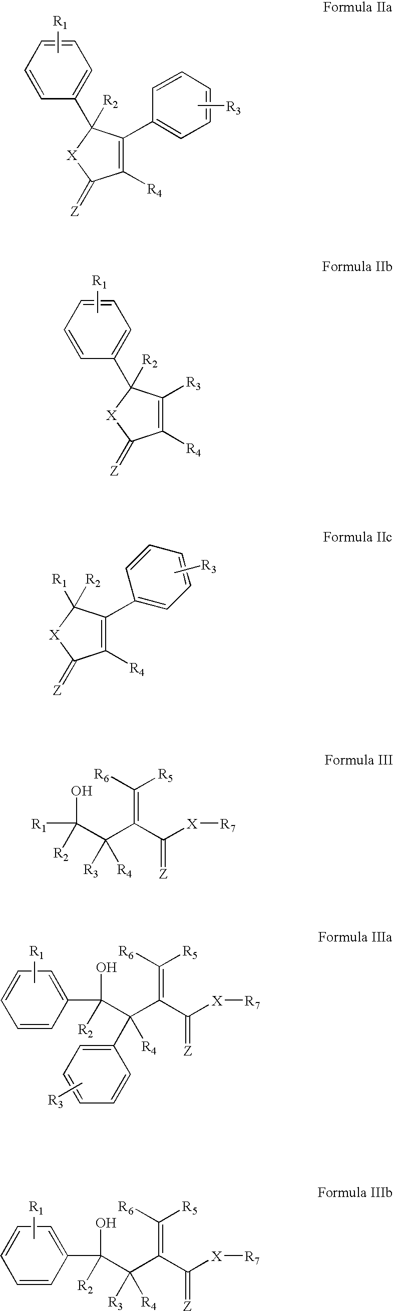 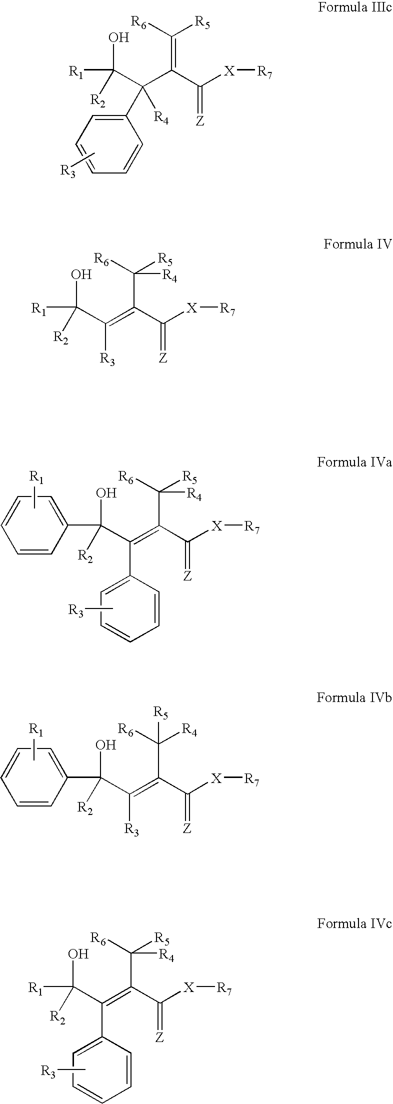
each of R₁-R₇ is selected from the group consisting of a hydrogen atom, a halogen atom, a hydroxyl group, and any other organic group containing any number of carbon atoms in a linear, branched, or cyclic structural format; and
each of X and Z is a heteroatom.

3. The compound of claim 2, wherein the other organic group contains 1-20 carbon atoms and optionally includes a heteroatom.

4. The compound of claim 3, wherein the heteroatom is oxygen, sulfur, or nitrogen.

5. The compound of claim 2, wherein each of R₁-R₇ is selected from the group consisting of alkyl, substituted alkyl, alkenyl, substituted alkenyl, alkynyl, substituted alkynyl, phenyl, substituted phenyl, aryl, substituted aryl, heteroaryl, and substituted heteroaryl.

6. The compound of claim 5, wherein each of the substituted alkyl, alkenyl, alkynyl, phenyl, aryl, and heteroaryl contains a substitution selected from the group consisting of halo, hydroxyl, alkoxy, alkylthio, phenoxy, aryoxy, cyano, isocyano, carbonyl, carboxyl, amino, amido, sulfonyl, and substituted heterocyclic.

7. The compound of claim 2, wherein the heteroatom is oxygen, sulfur, or nitrogen.

8. The compound of claim 2, wherein the compound is selected from the group consisting of CT10-16 and 19-22.

9. A method for preparing a compound of Formula I or II, comprising:
contacting a Baylis-Hillman acetate adduct with bis(pinacolato)diboron, followed by treatment of CBr₄ and PPh₃, to form a homoallylic alcohol; and
contacting the homoallylic alcohol with carbon tetrabromide and triphenylphosphene under a nitrogen atmosphere to form a trans-α-methylenelactone, or
contacting the homoallylic alcohol with p-toluenesulfonic acid under a nitrogen atmosphere to form a cis-α-methylene-lactone.

10. A method for preparing a compound of Formula III or IV, comprising contacting a Baylis-Hillman acetate adduct with bis(pinacolato)diboron in the presence of a palladium catalyst under a nitrogen atmosphere followed by BF₃ and an aldehyde to form a homoallylic alcohol.

11. A composition comprising the compound of claim 1 and a pharmaceutically acceptable carrier.

12. A composition comprising a pharmaceutically acceptable carrier and a compound selected from the group consisting of PH1-37 and compounds of Formula V.

13. A method of binding tubulin to a compound, comprising contacting tubulin with a compound, or a pharmaceutically acceptable salt, solvate, or hydrate thereof, wherein
the compound comprises a first hydrophobic aromatic group (HYR1), a second hydrophobic aromatic group (HYR2), a hydrophobic group (HYA), and an H-bond acceptor (HBA);
HYR1, HYR2, HYA, and HBA are configured according to FIG. 1(a), the distance between HYR1 and HYR2 is 4.37±1 Å, the distance between HYR1 and HYA is 6.29±1 Å, the distance between HYR1 and HBA is 3.72±1 Å, the distance between HYR2 and HYA is 4.36±1 Å, the distance between HYR2 and HBA is 4.51±1 Å, and the distance between HYA and HBA is 3.57±1 Å; and
the compound is not any of TPI1-7.

14. The method of claim 13, wherein the compound is a compound of claim 1.

15. The method of claim 14, wherein the compound is a compound of claim 2.

16. The method of claim 13, wherein the compound is selected from the group consisting of PH1-37 and compounds of Formula V.

17. The method of claim 13, wherein the compound is selected from the group consisting of CT10-16 and 19-23.

18. A method for modulating cell growth, cell cycle, or cell death, comprising contacting a cell with a compound, or a pharmaceutically acceptable salt, solvate, or hydrate thereof, wherein
the compound comprises a first hydrophobic aromatic group (HYR1), a second hydrophobic aromatic group (HYR2), a hydrophobic group (HYA), and an H-bond acceptor (HBA);
HYR1, HYR2, HYA, and HBA are configured according to FIG. 1(a), the distance between HYR1 and HYR2 is 4.37±1 Å, the distance between HYR1 and HYA is 6.29±1 Å, the distance between HYR1 and HBA is 3.72±1 Å, the distance between HYR2 and HYA is 4.36±1 Å, the distance between HYR2 and HBA is 4.51±1 Å, and the distance between HYA and HBA is 3.57±1 Å; and
the compound is not any of TPI1-7.

19. The method of claim 18, wherein the compound is a compound of claim 1.

20. The method of claim 19, wherein the compound is a compound of claim 2.

21. The method of claim 18, wherein the compound is selected from the group consisting of PH1-37 and compounds of Formula V.

22. The method of claim 18, wherein the compound is selected from the group consisting of CT10-16 and 19-23.

23. The method of claim 18, wherein the cell is a cancer cell or a cell associated with an abnormal cell proliferation disorder.

24. The method of claim 23, wherein the cancer is selected from the group consisting of colon cancer, breast cancer, lung cancer, ovarian cancer, brain cancer, prostate cancer, leukemia, and lymphoma, and the abnormal cell proliferation disorder is selected from the group consisting of angiogenesis disorders, immune mediated and non-immune mediated inflammatory diseases, arthritis, age-related macular degeneration, and diabetes.

25. The method of claim 23, wherein the cell is in a subject suffering from the cancer or the abnormal cell proliferation disorder.

26. A computer-readable medium comprising a representation of a pharmacophore, wherein
the pharmacophore includes features of a first hydrophobic aromatic group (HYR1), a second hydrophobic aromatic group (HYR2), a hydrophobic group (HYA), and an H-bond acceptor (HBA); and
HYR1, HYR2, HYA, and HBA are configured according to FIG. 1(a), the distance between HYR1 and HYR2 is 4.37±1 Å, the distance between HYR1 and HYA is 6.29±1 Å, the distance between HYR1 and HBA is 3.72±1 Å, the distance between HYR2 and HYA is 4.36±1 Å, the distance between HYR2 and HBA is 4.51±1 Å, and the distance between HYA and HBA is 3.57±1 Å.

27. A method for identifying a small molecule compound, comprising:
comparing the three-dimensional structure of a test compound with the three-dimensional structure of a pharmacophore, wherein the pharmacophore includes features of a first hydrophobic aromatic group (HYR1), a second hydrophobic aromatic group (HYR2), a hydrophobic group (HYA), and an H-bond acceptor (HBA), and wherein HYR1, HYR2, HYA, and HBA are configured according to FIG. 1(a), the distance between HYR1 and HYR2 is 4.37±1 Å, the distance between HYR1 and HYA is 6.29±1 Å, the distance between HYR1 and HBA is 3.72±1 Å, the distance between HYR2 and HYA is 4.36±1 Å, the distance between HYR2 and HBA is 4.51±1 Å, and the distance between HYA and HBA is 3.57±1 Å; and
selecting the test compound if the test compound conforms to the features of the pharmacophore.
